(19) United States
(12) Patent Application Publication
(10) Pub. No.: US 2024/0416970 A1
(43) Pub. Date: Dec. 19, 2024

(54) Driving Assistance System and Driving Assistance Method for a Vehicle

(71) Applicant: Bayerische Motoren Werke Aktiengesellschaft, Muenchen (DE)

(72) Inventor: Johannes ECHTLER, Hohenpeisenberg (DE)

(21) Appl. No.: 18/740,679

(22) Filed: Jun. 12, 2024

(30) Foreign Application Priority Data
Jun. 13, 2023 (DE) 10 2023 115 297.1

(51) Int. Cl. B60W 60/00

(52) U.S. Cl. CPC B60W 60/0059; B60W 60/001; B60W 60/0053; B60W 2554/4026; B60W 2554/4029; B60W 2554/4041; B60W 2554/4044; B60W 2554/80

(57) ABSTRACT

The present disclosure relates to a driving assistance system for a vehicle, including an object identification module which is configured to carry out an object identification process in a vehicle environment based on environmental data from an environmental sensor system of the vehicle; an analysis module which is configured to validate a categorization of an object as a vulnerable road user, the categorization having been carried out by the object identification module, wherein the analysis module is configured to carry out the validation based on at least one movement property of the object; and a driving assistance module which is configured to carry out driving assistance for automated driving based on the validation.

### CROSS REFERENCE TO RELATED APPLICATION

This application claims priority under 35 U.S.C. § 119 from German Patent Application No. DE 10 2023 115 297.1, filed Jun. 13, 2023, the entire disclosure of which is herein expressly incorporated by reference.

### BACKGROUND AND SUMMARY

The present disclosure relates to a driving assistance system for a vehicle, to a vehicle having such a driving assistance system, to a driving assistance method for a vehicle and to a storage medium for executing the driving assistance method. The present disclosure relates in particular to an evaluation of movement patterns for identifying and checking the plausibility of vulnerable road users, such as pedestrians and cyclists.

### PRIOR ART

The development of driving assistance functions, for example for (partly) autonomous driving, is becoming increasingly important. In order to enable the most precise environmental perception for driver assistance systems, it is possible to use sensor measurements from various sensor types, such as cameras, LiDAR and radars, for example. Each type of sensor is subject to different physical measurement principles. In reality, the vehicle environment consists of many different objects/subjects, such as different types of vehicles, people and animals, static objects such as garbage cans, traffic control systems, natural objects and terrain. Since the perception of all of these objects/subjects is also dependent in each case on the measuring principle used, it is difficult to ensure accurate environmental perception.

In particular, despite the large number of sensors, it may be difficult to reliably detect certain road users. If identifications are incorrect, these may lead to a deterioration in the performance of the driving assistance system. For example, a traffic jam assistant deactivates the driving assistance if a pedestrian or cyclist is identified. However, if an object, such as a motorcycle, for example, is mistakenly identified as a pedestrian or cyclist, the driving assistance is deactivated without reason, which may cause the user to stop using the driving assistance in the future due to poor performance. Deactivating the driving assistance can have a negative impact on road safety, since the driving assistance often offers more safety in comparison with manual drivers.

### DISCLOSURE OF THE INVENTION

It is an object of the present disclosure to specify a driving assistance system for automated driving of a vehicle, a vehicle having such a driving assistance system, a driving assistance method for automated driving of a vehicle and a storage medium for executing the driving assistance method which makes it possible to reliably identify road users, in particular vulnerable road users. In particular, it is an object of the present disclosure to maximize a service life of the driving assistance system and thus to increase road safety.

This object is achieved by the subject matter of the independent claims. Advantageous refinements are specified in the dependent claims.

According to an independent aspect of the present disclosure, what is specified is a driving assistance system for a vehicle, in particular a motor vehicle. The driving assistance system comprises an object identification module which is configured to carry out an object identification process in a vehicle environment based on environmental data from an environmental sensor system of the vehicle; an analysis module which is configured to validate a categorization of an object as a vulnerable road user, the categorization having been carried out by the object identification module, wherein the analysis module is configured to carry out the validation based on at least one movement property of the object; and a driving assistance module which is configured to carry out driving assistance for automated driving based on the validation.

According to the invention, a filter algorithm for checking the plausibility of vulnerable road users is provided subsequent to an object identification process. In this case, within an object identification process, a vulnerable road user, such as a cyclist or pedestrian, for example, is first identified. This identification is then validated or the plausibility thereof is checked based on a movement pattern of the vulnerable road user identified in the object identification process. If it is identified in the validation or plausibility check that the movement pattern is not typical for a vulnerable road user, it is assumed that the object identification was erroneous. For example, a cyclist identified in the object identification process may approach the ego vehicle from behind at a high speed (e.g., 45 km/h) and so it can be assumed that this object is not a cyclist, but a motorcyclist. In this case, for example, a traffic jam assistant cannot be deactivated. As a result, road users can be reliably identified, especially vulnerable road users.

The environmental sensor system preferably comprises at least one LiDAR system and/or at least one radar system and/or at least one camera and/or at least one ultrasound system. The environmental sensor system can provide the environmental data (also referred to as “surroundings data”) that represent an environmental area of the vehicle.

The categorization preferably includes, or is, a classification. In particular, the object identification module can be configured in the context of the object identification process to classify the vehicle environment based on the environmental data from the environmental sensor system. In the context of environment identification, classification is generally understood as the labeling of objects and/or subjects identified in the surroundings data (e.g., “vehicle”, “pedestrian”, “cyclist”, etc.).

The vehicle environment is preferably classified using semantic segmentation. The term “semantic segmentation” is generally understood to mean a classification of image segments or pixels of an input image in a (fixed) number of classes. In particular, in semantic segmentation, each pixel of an image is assigned a semantic meaning, for example, for distinguishing between cars, pedestrians, bicycles, roads, curbs, buildings, masts, signs, etc. Semantic segmentation can in this case assign a meaning to each individual pixel of the input image, both for uncountable “stuff” classes (e.g., roads) and for countable “thing” classes (e.g., vehicles or persons).

The classification of the vehicle environment, in particular the semantic segmentation, preferably uses a neural network.

The vulnerable road user is preferably selected from the group comprising a pedestrian, a cyclist, a wheelchair user and an e-scooter, or consisting thereof.

The vulnerable road user is preferably referred to as a VRU. The term “vulnerable road user” as used in the context of this disclosure generally refers to those road users who carry a particular risk of being injured or killed in road traffic because they are not surrounded by a protective cover such as a driver's cab. In particular, the vulnerable road users include pedestrians and/or cyclists.

The driving assistance system, in particular the object identification module or the analysis module, is preferably configured to identify the at least one movement property of the object based on the environmental data from the environmental sensor system.

The at least one movement property preferably comprises a relative position of the object in relation to the vehicle.

In addition or as an alternative, the at least one movement property comprises a movement path or a movement trajectory of the object over time, in particular over several frames of the environmental sensor system. For example, the movement path of the object may be typical for a motorcyclist (e.g., a snake line in traffic for overtaking motor vehicles), and so it can be concluded that the vulnerable road user identified in the object identification process is not such a user.

In addition or as an alternative, the at least one movement property comprises a speed of the object. For example, the object may move at a speed equal to or greater than a threshold, and so it can be concluded that the vulnerable road user identified in the object identification process is not such a user. For example, the threshold may be 30 km/h or more, 35 km/h or more, 40 km/h or more, 45 km/h or more, or 50 km/h or more.

In addition or as an alternative, the at least one movement property comprises an absolute position of the object. For example, the object may be located on a cycle path, and so it may be possible to check the plausibility that the cyclist identified in the object identification process is actually such a user.

The driving assistance system, in particular the object identification module or the analysis module, is preferably configured to determine a movement pattern of the object based on the at least one movement property and use same for the validation. For example, the movement pattern may include, but is not limited to, the movement path or the movement trajectory and the speed of the object.

The analysis module is preferably configured to reject the categorization of the object as a vulnerable road user carried out by the object identification module if the at least one movement property deviates from a characteristic movement behavior of vulnerable road users; and confirm the categorization of the object as a vulnerable road user carried out by the object identification module if the at least one movement property corresponds to the characteristic movement behavior of vulnerable road users. The characteristic movement behavior may relate to a movement path and/or a speed, for example.

The driving assistance module is preferably configured to deactivate the driving assistance for automated driving or block it from being activated, for example, by way of a user, if the categorization of the object as a vulnerable road user carried out by the object identification module is confirmed by the analysis module; and leave the driving assistance for automated driving activated or permit activation thereof, for example, by way of a user, if the categorization of the object as a vulnerable road user carried out by the object identification module is rejected by the analysis module.

The analysis module is preferably configured to reject the categorization of the object as a vulnerable road user carried out by the object identification module if an object speed of the object is equal to or greater than a threshold and the object moves away from the vehicle or toward the vehicle. For example, the object may move at a speed equal to or greater than the threshold, away from the vehicle or toward the vehicle (e.g., a motorcycle rapidly approaching from behind) and so it can be concluded that the vulnerable road user identified in the object identification process is not such a user.

In some embodiments, the threshold may be 30 km/h or more, 35 km/h or more, 40 km/h or more, 45 km/h or more, or 50 km/h or more.

The analysis module is preferably configured to determine in the context of the validation whether the vulnerable road user is a vulnerable road user relevant to a driving behavior of the vehicle if the vulnerable road user identified in the object identification process is validated as such a user. Particularly those objects with which there is a risk of collision due to the driving behavior of the vehicle (e.g., travel trajectory and speed) as well as the movement behavior of the object (e.g., movement trajectory and speed) are considered to be relevant.

In one example, the analysis module may determine that the vulnerable road user identified in the object identification process is actually such a user, but the vulnerable road user and the ego vehicle move away from one another. In this case, it may be an irrelevant vulnerable road user and, for example, no driving assistance, such as traffic jam assistance, can be switched off.

In another example, the analysis module may determine that the vulnerable road user identified in the object identification process is actually such a user, and the vulnerable road user and the ego vehicle move toward one another. In this case, it may be a relevant vulnerable road user and, for example, driving assistance, such as traffic jam assistance, can be switched off.

According to a further independent aspect of the present disclosure, what is specified is a vehicle, in particular a motor vehicle. The vehicle comprises the driving assistance system according to the embodiments of the present disclosure.

The term vehicle comprises automobiles, trucks, buses, RVs, motorcycles, etc. used to transport people, goods, etc. The term in particular comprises passenger transport motor vehicles.

The driving assistance system is configured for automated driving.

Within the scope of the document, the term “automated driving” is understood to mean driving with automated longitudinal and/or transverse guidance. Automated driving can involve, for example, driving on the freeway for a longer period of time or driving for a limited period of time during parking. The term “automated driving” comprises automated driving with any degree of automation. Examples of degrees of automation are assisted, partly automated, conditionally automated, highly automated and fully automated driving (with an increasing degree of automation in each case). The above-mentioned five degrees of automation correspond to SAE levels 1 to 5 of the SAE J3016 (SAE-Society of Automotive Engineering) standard as at Apr. 30, 2021.

In assisted driving (SAE level 1), the system performs longitudinal or transverse guidance in certain driving situations. In partially automated driving (SAE level 2), the system takes over the longitudinal and transverse guidance in certain driving situations, wherein the driver must permanently monitor the system like in assisted driving. In conditionally automated driving (SAE level 3), the system takes over the longitudinal and transverse guidance in certain driving situations without the driver having to permanently monitor the system; however, the driver must be able to take over the vehicle guidance in a certain time on request by the system. In highly automated driving (SAE level 4), the system takes over the vehicle guidance in certain driving situations, even if the driver does not react to a request for intervention, so that the driver is omitted as a fallback level. In fully automated driving (SAE level 5), the system can perform all aspects of the dynamic driving task under any carriageway and environmental conditions, which are also controlled by a human driver.

In addition, the term “at least partly automated driving or maneuvering” within the framework of the document also means partly automated, conditionally automated, highly automated, fully automated driving. In other words, the term “at least partly automated driving” means an automation level above SAE level 2.

The driving assistance system is preferably configured for automated driving in accordance with SAE level 2. For example, the driving assistance system may be a traffic jam assistant or implement a traffic jam assistant.

According to another independent aspect of the present disclosure, what is specified is a driving assistance method for a vehicle, in particular a motor vehicle. The driving assistance method comprises carrying out, by means of an object identification module, an object identification process in a vehicle environment based on environmental data from an environmental sensor system of the vehicle; carrying out, by means of an analysis module, a validation of a categorization of an object as a vulnerable road user, the categorization having been carried out by the object identification module, wherein the analysis module is configured to carry out the validation based on at least one movement property of the object; and carrying out driving assistance for automated driving based on the validation.

The driving assistance method for a vehicle can implement the aspects of the driving assistance system described in this document.

According to another independent aspect of the present disclosure, what is specified is a software (SW) program. The SW program may be configured to be executed on one or more processors in order thereby to execute the driving assistance method described in this document for a vehicle.

According to another independent aspect of the present disclosure, what is specified is a storage medium. The storage medium may comprise an SW program that is designed to be executed on one or more processors in order thereby to execute the driving assistance method described in this document for a vehicle.

According to another independent aspect of the present disclosure, what is specified is a software comprising program code. The software is configured for carrying out the driving assistance method for a vehicle when the software runs on one or more software-controlled devices.

According to a further independent aspect of the present disclosure, what is specified is a driving assistance system for a vehicle. The driving assistance system comprises one or more processors; and at least one memory connected to the one or more processors and containing instructions that can be executed by the one or more processors to carry out the driving assistance method described in this document for a vehicle.

A processor or a processor module is a programmable arithmetic unit, that is to say a machine or an electronic circuit, that controls other elements in accordance with transmitted commands and in the process drives an algorithm (process).

Exemplary embodiments of the disclosure are illustrated in the figures and are described in more detail below, in which:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 schematically shows a vehicle having a driving assistance system for automated driving according to embodiments of the present disclosure,

FIG. 2 schematically shows a driving assistance system for a vehicle according to embodiments of the present disclosure,

FIG. 3A schematically shows a vehicle and an object according to embodiments of the present disclosure,

FIG. 3B schematically shows a vehicle and an object according to further embodiments of the present disclosure, and

FIG. 4 schematically shows a flowchart of a driving assistance method according to embodiments of the present disclosure.

### DETAILED DESCRIPTION OF THE DRAWINGS

Unless indicated otherwise, the same reference signs are used for identical and functionally identical elements below.

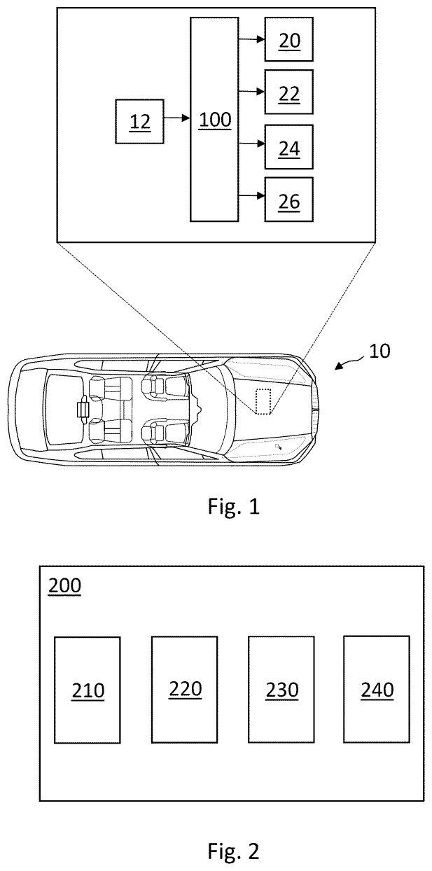

FIG. 1 schematically shows a vehicle 10 having a driving assistance system 100 for automated driving according to embodiments of the present disclosure.

In automated driving, the longitudinal and/or lateral guidance of the vehicle 10 is carried out automatically. The driving assistance system 100 thus takes on the vehicle guidance. To this end, the driving assistance system 100 controls the drive 20, the gear mechanism 22, the (for example hydraulic) operating brake 24 and the steering system 26 via intermediate units, which are not illustrated.

In order to plan and carry out automated driving, environmental information from an environmental sensor system which monitors the vehicle environment is received by the driving assistance system 100. In particular, the vehicle can comprise at least one environmental sensor 12 which is configured to record environmental data which indicate the vehicle environment. The at least one environmental sensor 12 can comprise, for example, one or more LiDAR systems, one or more radar systems, one or more ultrasound sensors and/or one or more cameras.

The driving assistance system 100 is preferably configured for automated driving in accordance with SAE level 2. For example, the driving assistance system 100 may be a traffic jam assistant or implement a traffic jam assistant.

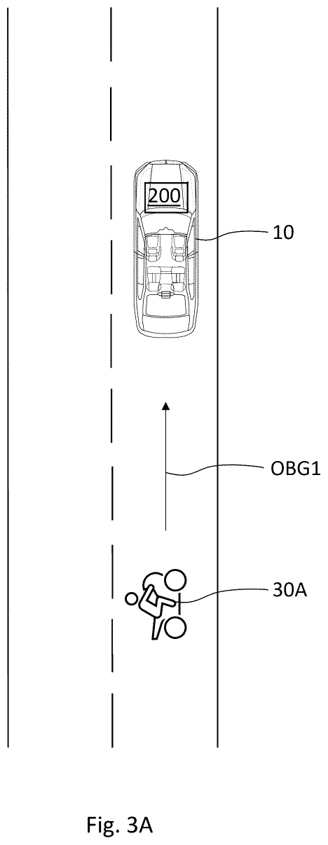

FIG. 2 schematically shows a driving assistance system 200 for a vehicle system according to embodiments of the present disclosure. The driving assistance system 200 may be the driving assistance system described in relation to FIG. 1.

The driving assistance system 200 comprises an object identification module 220 which is configured to carry out an object identification process in a vehicle environment based on environmental data from an environmental sensor system 210 of the vehicle; an analysis module 230 which is configured to validate a categorization of an object as a vulnerable road user, the categorization having been carried out by the object identification module 220, wherein the analysis module 230 is configured to carry out the validation based on at least one movement property of the object; and a driving assistance module 240 which is configured to carry out driving assistance for automated driving based on the validation.

The object identification module 220 and/or the analysis module 230 and/or the driving assistance module 240 can be realized in a common software and/or hardware module. As an alternative thereto, the object identification module 220 and/or the analysis module 230 and/or the driving assistance module 240 can each be realized in a separate software and/or hardware module.

For example, the vulnerable road user may be a pedestrian, a cyclist, a wheelchair user or an e-scooter. In particular, the vulnerable road user may be referred to as a VRU.

The driving assistance system 200 may be configured to identify the at least one movement property of the object based on the environmental data of the environmental sensor system 210. The driving assistance system 200 can determine, for example, a movement pattern of the object based on the at least one movement property and use it for validation. For example, the movement pattern may include, but is not limited to, the movement path or the movement trajectory and the speed of the object.

The at least one movement property preferably comprises a relative position of the object in relation to the vehicle.

In addition or as an alternative, the at least one movement property comprises a movement path or a movement trajectory of the object over time, in particular over several frames of the environmental sensor system 210. For example, the movement path of the object may be typical for a motorcyclist (e.g., a snake line in traffic for overtaking motor vehicles), and so it can be concluded that the vulnerable road user identified in the object identification process is not such a user.

In addition or as an alternative, the at least one movement property comprises a speed of the object. For example, the object may move at a speed equal to or greater than a threshold, and so it can be concluded that the vulnerable road user identified in the object identification process is not such a user. For example, the threshold may be 30 km/h or more, 35 km/h or more, 40 km/h or more, 45 km/h or more, or 50 km/h or more.

In addition or as an alternative, the at least one movement property comprises an absolute position of the object. For example, the object may be located on a cycle path, and so it may be possible to check the plausibility that the cyclist identified in the object identification process is actually such a user.

In some embodiments, the analysis module 230 may be configured to reject the categorization of the object as a vulnerable road user carried out by the object identification module 220 if the at least one movement property deviates from a characteristic movement behavior of vulnerable road users; and confirm the categorization of the object as a vulnerable road user carried out by the object identification module 220 if the at least one movement property corresponds to the characteristic movement behavior of vulnerable road users. The characteristic movement behavior may relate to a movement path and/or a speed, for example.

In some embodiments, the driving assistance module 240 may be configured to deactivate the driving assistance for automated driving or block it from being activated, for example by way of a user, if the categorization of the object as a vulnerable road user carried out by the object identification module 220 is confirmed by the analysis module 230; and leave the driving assistance for automated driving activated or permit activation thereof, for example by way of a user, if the categorization of the object as a vulnerable road user carried out by the object identification module 220 is rejected by the analysis module 230.

The analysis module 230 is preferably also configured to determine in the context of the validation whether the vulnerable road user is a vulnerable road user relevant to a driving behavior of the vehicle if the vulnerable road user identified in the object identification process is validated as such. Particularly those objects with which there is a risk of collision due to the driving behavior of the vehicle (e.g., travel trajectory and speed) as well as the movement behavior of the object (e.g., movement trajectory and speed) are considered to be relevant.

In one example, the analysis module 230 may determine that the vulnerable road user identified in the object identification process is actually such, but the vulnerable road user and the ego vehicle move away from one another. In this case, it may be an irrelevant vulnerable road user and, for example, no driving assistance, such as traffic jam assistance, can be switched off.

In another example, the analysis module 230 may determine that the vulnerable road user identified in the object identification process is actually such, and the vulnerable road user and the ego vehicle move toward one another. In this case, it may be a relevant vulnerable road user and, for example, driving assistance, such as traffic jam assistance, can be switched off.

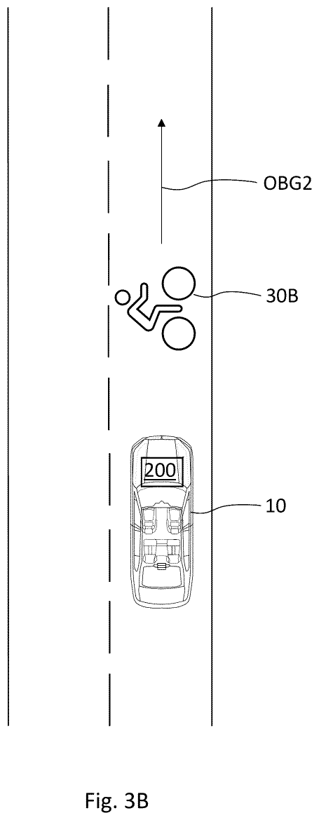

FIG. 3A shows schematically shows a vehicle 10 and an object 30A according to embodiments of the present disclosure.

In some embodiments, the driving assistance system may be configured to reject the categorization of the object 30A as a vulnerable road user carried out in the object identification process if an object speed OBG1 of the object 30A is equal to or greater than a threshold and the object 30A moves toward the vehicle 10. For example, the threshold may be 30 km/h or more, 35 km/h or more, 40 km/h or more, 45 km/h or more, or 50 km/h or more.

For example, the object 30A can move toward the vehicle 10 at a speed OBG1 equal to or greater than the threshold, such as the motorcycle shown in FIG. 3A approaching rapidly from the rear, for example. It can therefore be concluded that the vulnerable road user identified in the object identification process is not such a user. In this case, the driving assistance system, such as a traffic jam assistant, cannot be switched off.

FIG. 3B shows schematically shows a vehicle 10 and an object 30B according to further embodiments of the present disclosure.

In some embodiments, the driving assistance system may be configured to confirm the categorization of the object 30B as a vulnerable road user carried out in the object identification process if an object speed OBG2 of the object 30B is equal to or lower than a threshold. For example, the threshold may be 30 km/h or less, 35 km/h or less, or 40 km/h or less.

For example, the object 30B can be located in front of the vehicle 10 at a speed OBG2 equal to or lower than the threshold, such as the bicycle shown in FIG. 3B, for example. It can therefore be concluded that the vulnerable road user identified in the object identification process is actually such a user. In this case, the driving assistance, such as traffic jam assistance, for example, can be switched off and the driver can take over the vehicle guidance.

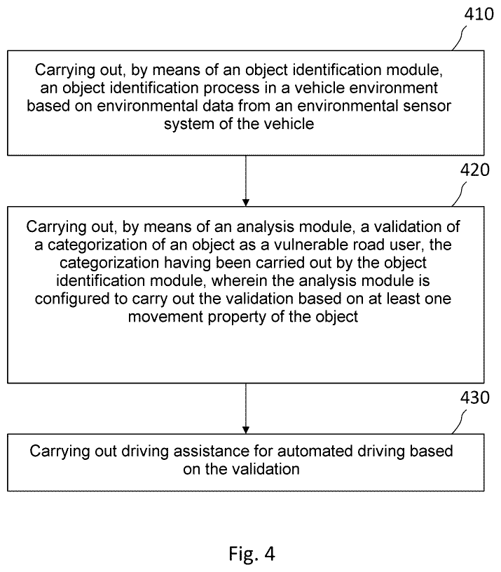

FIG. 4 shows a flowchart of a driving assistance method 400 according to embodiments of the present disclosure. The driving assistance method 400 may be implemented by appropriate software which is able to be executed by one or more processors (for example a CPU).

The driving assistance method 400 comprises in block 410 carrying out, by means of an object identification module, an object identification process in a vehicle environment based on environmental data from an environmental sensor system of the vehicle; in block 420 carrying out, by means of an analysis module, a validation of a categorization of an object as a vulnerable road user, the categorization having been carried out by the object identification module, wherein the analysis module is configured to carry out the validation based on at least one movement property of the object; and in block 430 carrying out driving assistance for automated driving based on the validation.

According to the invention, a filter algorithm for checking the plausibility of vulnerable road users is provided subsequent to an object identification process. In this case, within an object identification process, a vulnerable road user, such as a cyclist or pedestrian, for example, is first identified. This identification is then validated or the plausibility thereof is checked based on a movement pattern of the vulnerable road user identified in the object identification process. If it is identified in the validation or plausibility check that the movement pattern is not typical for a vulnerable road user, it is assumed that the object identification was erroneous. For example, a cyclist identified in the object identification process may approach the ego vehicle from behind at a high speed (e.g., 45 km/h) and so it can be assumed that this object is not a cyclist, but a motorcyclist. In this case, for example, a traffic jam assistant cannot be deactivated. As a result, road users can be reliably identified, especially vulnerable road users.

Although the invention has been explained and illustrated in more detail through preferred exemplary embodiments, the invention is not restricted to the disclosed examples and other variations may be derived therefrom by a person skilled in the art without departing from the scope of protection of the invention. It is therefore clear that there are a multiplicity of variation options. It is likewise clear that embodiments mentioned by way of example actually only constitute examples that should not be understood in any way as limiting for instance the scope of protection, the application options or the configuration of the invention. On the contrary, the above description and the description of the figures give a person skilled in the art the ability to implement the exemplary embodiments in specific terms, wherein a person skilled in the art with knowledge of the disclosed concept of the invention may make numerous modifications, for example with regard to the function or the arrangement of the individual elements mentioned in an exemplary embodiment, without departing from the scope of protection defined by the claims and their legal counterparts, such as for instance further explanations in the description.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A driving assistance system for a vehicle, comprising:
an object identification module configured to carry out an object identification process in a vehicle environment based on environmental data from an environmental sensor system of the vehicle;
an analysis module configured to validate a categorization of an object as a vulnerable road user, the categorization having been carried out by the object identification module, wherein the analysis module is configured to carry out validation based on at least one movement property of the object; and
a driving assistance module configured to carry out driving assistance for automated driving based on the validation.

2. The driving assistance system according to claim 1, wherein the at least one movement property comprises at least one of the following:
a relative position of the object in relation to the vehicle;
a movement path of the object over time, including several frames of the environmental sensor system;
a speed of the object; and
an absolute position of the object.

3. The driving assistance system according to claim 1, wherein the analysis module is configured to:
reject the categorization of the object as the vulnerable road user carried out by the object identification module in a case in which the at least one movement property deviates from a characteristic movement behavior of vulnerable road users; and
confirm the categorization of the object as the vulnerable road user carried out by the object identification module in a case in which the at least one movement property corresponds to the characteristic movement behavior of vulnerable road users.

4. The driving assistance system according to claim 3, wherein the driving assistance module is configured to:
deactivate the driving assistance for automated driving or block the driving assistance from being activated in a case in which the categorization of the object as the vulnerable road user carried out by the object identification module is confirmed by the analysis module; and
leave the driving assistance for automated driving activated or permit activation thereof in a case in which the categorization of the object as the vulnerable road user carried out by the object identification module is rejected by the analysis module.

5. The driving assistance system according to claim 1, wherein the analysis module is configured to reject the categorization of the object as the vulnerable road user carried out by the object identification module in a case in which an object speed of the object is equal to or greater than a threshold and the object moves away from the vehicle or toward the vehicle, wherein the threshold is 30 km/h or more, 35 km/h or more, 40 km/h or more, 45 km/h or more, or 50 km/h or more.

6. The driving assistance system according to claim 1, wherein the analysis module is configured to determine in a context of the validation whether the vulnerable road user is a vulnerable road user relevant to a driving behavior of the vehicle in a case in which the vulnerable road user identified in the object identification process is validated as such.

7. The driving assistance system according to claim 1, wherein the vulnerable road user is selected from a group consisting of a pedestrian, a cyclist, a wheelchair user and an e-scooter, wherein the vulnerable road user is referred to as a VRU.

8. A motor vehicle comprising the driving assistance system according to claim 1.

9. A driving assistance method for a vehicle, comprising:
carrying out, by an object identification module, an object identification process in a vehicle environment based on environmental data from an environmental sensor system of the vehicle;
carrying out, by an analysis module, a validation of a categorization of an object as a vulnerable road user, the categorization having been carried out by the object identification module, wherein the analysis module is configured to carry out the validation based on at least one movement property of the object; and
carrying out driving assistance for automated driving based on the validation.

10. A non-transitory computer-readable storage medium, comprising a software program which is configured to be executed on one or more processors to execute the driving assistance method according to claim 9.
